(19) United States
(12) Patent Application Publication
(10) Pub. No.: US 2008/0141987 A1
(43) Pub. Date: Jun. 19, 2008

(54) Ignition coil with wire rope core and method

(76) Inventors: Albert Anthony Skinner, El Paso, TX (US); Harry Oliver Levers, El Paso, TX (US); Colin Hamer, El Paso, TX (US)

Correspondence Address: DELPHI TECHNOLOGIES, INC., M/C 480-410-202, PO BOX 5052, TROY, MI, 48007, US

(21) Appl. No.: 11/638,722

(22) Filed: Dec. 14, 2006

(51) Int. Cl. H01F 38/12

(52) U.S. Cl. 123/634

(57) ABSTRACT

An ignition coil intended for application in automotive internal combustion engines includes a generally cylindrically magnetic core defining opposed first and second ends and a primary coil concentrically wound externally about the core axially between the opposed ends. A secondary coil assembly including an insulating spool and a secondary coil wound thereon is concentrically disposed externally of the primary coil and magnetic core. One terminal of the primary coil is connected to a controlled voltage source and the other terminal to an electrical ground. One terminal of the secondary coil is connected to the high voltage terminal of at least one spark plug and the other terminal is connected to an electrical ground. The magnetic core is constructed from low carbon steel rope, preferably in a 1x37 format.

### RELATED PATENT APPLICATION

This application is related to U.S. application Ser. No. 763,574 filed 10 Dec. 1996, entitled “Integrated Ignition Coil and Spark Plug”, now U.S. Pat. No. 5,706,792 issued 13 Jan. 1998, the specification of which is expressly incorporated herein by reference.

### TECHNICAL FIELD

The present invention is related to internal combustion engine ignition apparatus and, more particularly, to high voltage ignition source hardware.

### BACKGROUND OF THE INVENTION

Ignition apparatus for providing a spark to the combustion chamber of an internal combustion engine characterized by a combined spark plug and ignition coil have been proposed in the prior art. For example, U.S. Pat. No. 1,164,113 to Orswell entitled “Sparking Plug”, U.S. Pat. No. 1,302,308 to Cavanagh entitled “Spark Coil for Ignition”, U.S. Pat. No. 2,441,047 to Wall entitled “Transformer Spark Plug”, U.S. Pat. No. 2,459,856 to Wall entitled “Transformer Spark Plug”, U.S. Pat. No. 2,467,531 to Lamphere entitled “Ignition System and Spark Plug”, and U.S. Pat. No. 2,467,534 to Osterman entitled “Ignition Unit” all disclose combined ignition coils and spark plugs.

More recently, improved internal combustion engine ignition apparatus has been described in the patent literature. For example, U.S. Pat. No. 5,015,982 to Skinner et al. entitled “Ignition Coil”, U.S. Pat. No. 6,522,232 B2 to Paul et al. entitled “Ignition Apparatus Having Reduced Electric Field HV Terminal Arrangement”, U.S. Pat. No. 6,556,118 B1 to Skinner entitled “Separate Mount Ignition Coil Utilizing a Progressive Wound Secondary Winding”, and U.S. Pat. No. 6,679,236 B2 to Skinner et al. entitled Ignition System Having High Resistivity Core” all disclose commercially viable ignition coil designs.

Modern internal combustion engines, particularly those characterized by plural intake and exhaust valve arrangements and overhead cam valve actuation configurations, have very limited space available for providing structurally adequate spark plug wells. Unfortunately for single coil per cylinder spark sources, including combined spark plug and ignition coil apparatus, decreasing spark plug well diameter makes single coil per cylinder ignition systems difficult to successfully implement for a variety of reasons. Among the problems which must be overcome include limited diametrical clearance between the spark plug well and the ignition apparatus, high temperatures especially given the minimal clearances in the limited spark plug wells, and access for installation and removal of the spark plug and ignition coil.

Radio frequency interference (RFI) continues to be a challenge for ignition system designers. Unfortunately for single coil per cylinder spark sources, including combined spark plug and ignition coil apparatus, the nature of such installations do not afford much opportunity for shielding against such RFI. Additionally, each individual ignition source in such distributed single coil per cylinder systems has associated therewith a system voltage line to increasing the ease with which RFI generated by one ignition source may couple in cross talk to the other ignition sources respective system voltage supply lines. Additionally, each supply line may experience substantial direct capacitive coupling of RFI generated by the associated ignition source.

Ignition coils have been previously proposed which employ one of several known magnetic core configurations and materials. Cylindrical cores have been manufactured out of bundles formed of individual parallel strands of wire, steel laminations of varying widths and out of “solid” materials such as composite iron (plastic coated powdered iron) and soft ferrites. Although suitable for their intended application, such prior approaches could be difficult and relatively expensive to produce, particularly in large-scale production, such as in the automotive industry. Furthermore, certain prior approaches had inherent inefficiencies such as high eddy current losses, inefficient packing of conductors within an allocated volume and air pockets entrained within the composite materials forming the magnetic core.

### SUMMARY OF THE INVENTION

Therefore, it is an object of the present invention to provide a new, low cost and easily produced integrated spark plug and ignition coil apparatus.

It is preferred that such an apparatus shall include a magnetic core which is produced to net shape, avoiding blanking, post-forming machining and finishing operations to compactly fit within its assembled package within extremely slender spark plug access wells.

In the preferred embodiment of the invention, the inventive ignition coil apparatus includes a generally cylindrical magnetic core having opposed first and second ends with a secondary coil concentrically wound about the core between the first and second ends. A secondary coil assembly including an insulating spool and secondary coil wound thereon is concentrically disposed with the primary coil and magnetic core. Means are provided for electrically interconnecting one terminal of the primary coil to a controlled voltage source and another terminal to an electrical ground. Furthermore, means are provided for electrically interconnecting one terminal of the secondary coil to the high voltage terminal of one or more associated spark plugs and another terminal to an electrical ground. Finally, the magnetic core is composed of a wire rope formed of a plurality of helically arranged low carbon steel or iron strands extending between the first and second ends.

According to another aspect of the invention, a method of forming an ignition coil apparatus comprising a magnetic core, a primary coil and a secondary coil assembly including an insulating spool and secondary coil wound thereon, comprises the steps of drawing a predetermined length of wire rope from a substantially continuous supply, straightening the predetermined length of wire rope, wrapping a conductor about the length of the wire rope to form the primary coil, severing the length of wire rope from the continuous supply to form the magnetic core and concentrically positioning the magnetic core and primary coil within the secondary coil assembly.

It is further desired that, in one particular embodiment of the invention, an integrated spark plug and ignition apparatus package, including the inventive magnetic core, can physically be fit within extremely slender spark plug access wells and be able to adequately manage the extreme temperature conditions associated with such placement.

Additionally, it is desirable that an integrated spark plug and ignition coil minimize the radiation of RFI to the surroundings.

These and other objects of the invention are provided for in an improved integrated spark plug and ignition coil apparatus wherein the inherent capacitive and inductive characteristics are advantageously adapted for attenuation of RFI. In accordance with the present invention,

These and other features and advantages of this invention will become apparent upon reading the following specification, which, along with the drawings, describes preferred and alternative embodiments of the invention in detail.

### BRIEF DESCRIPTION OF THE DRAWINGS

The present invention will now be described, by way of example, with reference to the accompanying drawings, in which:

FIG. 1, is a cross-sectional view of a preferred embodiment of an integrated ignition coil and spark plug in accordance with the present invention;

FIG. 1A, is a fragmentary, cross-sectional view of a portion of FIG. 1, on an enlarged scale, illustrating structural details adjacent one end of the electromagnetic core;

FIG. 1B, is a fragmentary, cross-sectional view of a portion of FIG. 1, on an enlarged scale, illustrating structural details adjacent the other end of the electromagnetic core;

FIG. 2, is a simplified mechanical and electrical schematic illustration of the integrated ignition coil and spark plug in accordance with the present invention;

FIG. 3, represents an equivalent electrical circuit of an integrated ignition coil and spark plug in accordance with the present invention;

FIG. 4, is a cross-sectional view of a preferred wire rope construction employed as the electromagnetic core of the integrated ignition coil and spark plug of FIG. 1, on a greatly enlarged scale;

FIG. 5, is a cross-sectional view of an alternative wire rope construction employed as the electromagnetic core of the integrated ignition coil and spark plug of FIG. 1, on a greatly enlarged scale; and

FIG. 6, is schematic diagram of a manufacturing line for processing the electromagnetic core and primary coil assemble of the integrated ignition coil and spark plug of FIG. 1.

Although the drawings represent embodiments of the present invention, the drawings are not necessarily to scale and certain features may be exaggerated in order to illustrate and explain the present invention. The exemplification set forth herein illustrates an embodiment of the invention, in one form, and such exemplifications are not to be construed as limiting the scope of the invention in any manner.

### DESCRIPTION OF THE PREFERRED EMBODIMENT

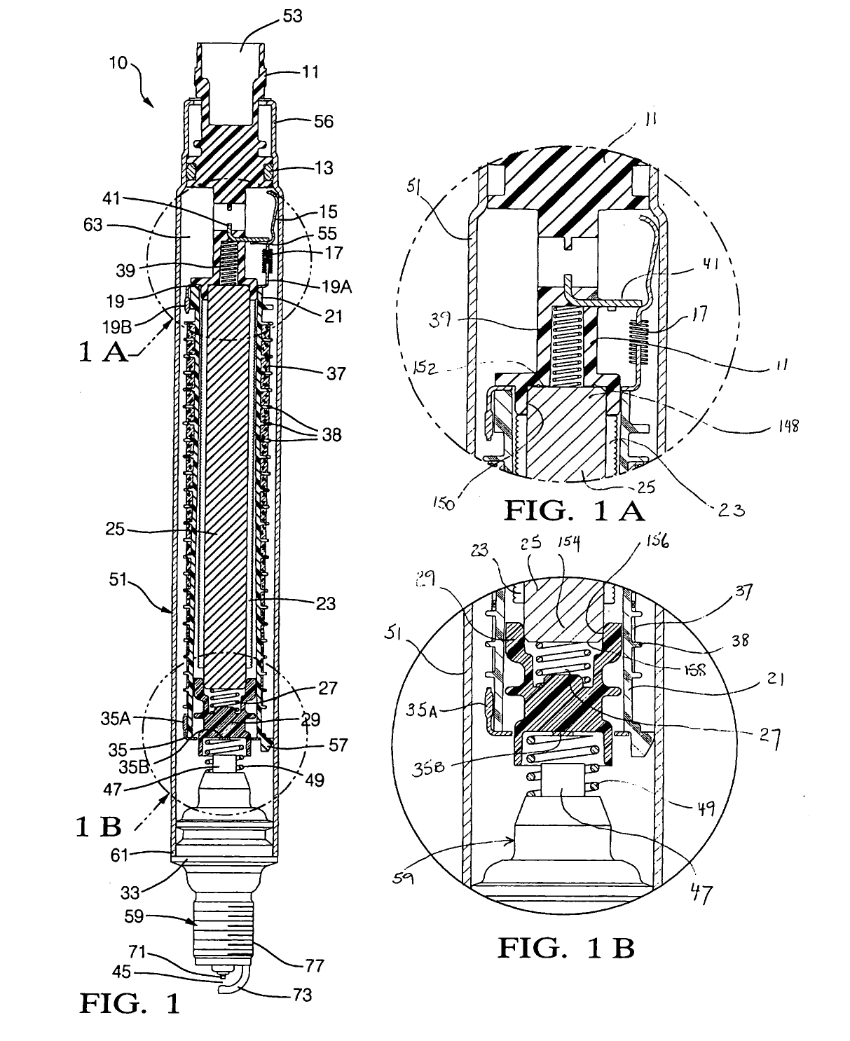

Referring to the figures, and particularly to FIGS. 1, 1A and 1B, a preferred embodiment of an integrated ignition coil and spark plug assembly in accordance with the present invention is illustrated in partial sectional view and is generally designated by the reference numeral 10. The integrated ignition coil and spark plug assembly 10 is adapted for installation with a conventional internal combustion engine through a spark plug well and in threaded engagement with a spark plug opening into an engine combustion chamber. The assembly 10 has a substantially rigid outer case 51 at one end of which is a spark plug assembly 59 and at the other end of which is a connector body 11 for establishing an external electrical interface. The assembly 10 further comprises a substantially slender high voltage transformer including substantially coaxially arranged primary and secondary windings and a high permeability magnetic core. All high voltage ignition system components are housed within or are not part of the integrated ignition coil and spark plug assembly 10.

Generally, the structure is adapted for drop-in assembly of components and sub-assemblies as later described.

A secondary spool 21 is formed from an injection molded plastic insulating material having a high temperature tolerance such as a polybutylene terephthalate (PBT) thermoplastic polyester for example sold under the trade name Valox® by General Electric. The spool 21 has a plurality of axially spaced, radially outwardly directed ribs 38. Adjacent pairs of ribs 38 define channels therebetween. The radial depth of the respective channels decreases from one end of the spool 21 to the other by way of a progressive gradual flare of the spool body 21 away from the primary coil 23 such that the space between the inner diameter of spool 21 and the primary winding 23 progressively increases from the connector body end to the spark plug end of the assembly 10. The voltage gradient in the axial direction which increases toward the spark plug end of the secondary coil 37 requires increased dielectric insulation between the secondary and primary coils 37 and 23, respectively, and is provided for by way of the progressively increased separation between the secondary and primary coils 37 and 23, respectively, and dielectric fluid therebetween as described in a later point. A spacer 29, also preferably a terephthalate (PBT) thermoplastic such as Valox®, and a spring 27 are fitted to the interior of secondary spool 21 at the end thereof having the shallowest channels between ribs 38. A secondary grounding terminal 19 and a secondary negative terminal 35 are hot upset to secure the respective secondary terminals 19, 35 to the secondary spool 21. Secondary coil 37 is then wound on the spool 21 between ribs 38 which defines winding slots. Secondary coil 37 has more turns in the deeper channels relative to fewer turns in the progressively shallower channels. In the present embodiment, the secondary spool 21 has 23 channels which are wound to fabricate the secondary coil 37. For example, in the exemplary embodiment, secondary coil 37 may be comprised of 24,893 total turns of No. 44 AWG wire, the number of turns in each channel being progressively reduced from the previous channel in accordance with the progressive reduction in channel depths. All 23 channel windings are electrically connected in series by cross-over connections that extend through slots in the ribs 38. Such a coil arrangement is generally referred to in the art as a segment wound coil and is generally preferred over conventional layer wound coils for reasons of manufacturing simplicity and decreased capacitance.

The low voltage or ground lead of secondary coil 37 is terminated to a tang 19B of the secondary grounding terminal 19, and the negative lead of the secondary coil 37 is terminated to a tang 35A of the secondary negative terminal 35. Both terminal leads of the secondary coil 37 are wrapped and then soldered such as by hot dip solder operation. Respective tangs 19B and 35A are folded toward one another against the secondary spool 21 to lie substantially axially against or in proximity to the secondary spool 21.

In previous designs, such as that described in U.S. Pat. No. 5,706,792, the core of an integrated ignition coil and spark plug assembly is manufactured from plastic coated iron particles in a compression molding operation. The iron particles are carried by a binder of electrical insulating material. The iron particles may have a mean particle size of about 0.004 inches. In production of a part, the iron particles are coated with a liquid thermoplastic material which encapsulates the individual particles. The coated iron particles are placed in a heated mold press where the composite material is compressed to the desired shape and density. The final molded part is then comprised of iron particles in a binder of cured thermoplastic material. By way of example, the final molded part may be, by weight, about 99% iron particles and about 1% plastic material. By volume, the part may be about 96% iron particles and about 4% plastic material. Because of the elongated shape of a core produced by this process, the type of compression molding process utilized applies primary compressive forces normal to the major axis of the piece to provide uniform compaction throughout. Such core fabrication was previously preferred since cost effective round cross section cores may be produced thereby. After the core is molded, it is finish machined such as by grinding to provide a smooth surface absent, for example, sharp molding parting lines otherwise detrimental to the intended direct primary coil winding thereon.

The applicants have determined that the core 25, when formed of a length of braided, woven or twist-formed material such as low carbon steel strands (also known as iron or steel rope), can provide adequate performance within the integrated ignition coil and spark plug assembly 10 described herein. Furthermore, the use of iron rope substantially reduces the material and manufacturing processing costs of the core 25. Conceptually, standard bulk iron rope can be purchased in continuous form as a reel or coil. Thereafter, a segment of the rope would be locally straightened, have a coating of heat resistant material (tape, heat shrink tubing, etc.) applied to cover the outer surface thereof and then cut to a required length. The preferred embodiment would employ standard 1x37 type wire rope construction to minimize the diameter of the individual wire strands to minimize eddy current losses. Alternatively, a 1x19 type wire rope construction can also be employed, but would result in increased eddy current losses within the individual strands. The minimal contact between adjacent round wire strands in the wire rope construction limits the eddy current flow between wires to negligible levels, thus allowing standard coatings for corrosion, such as zinc, to be used. The twist in the wire rope, which inherently serves to hold it together, results in no adverse thermal or magnetic properties when used as an ignition core which are detrimental to overall performance of integrated ignition coil and spark plug assembly 10. The twist does, however, have the distinct advantage of allowing the severed length of wire rope forming the core 25 to maintain its form and eliminates the necessity of expensive production tools and secondary machining operations. Another option for using wire rope as an ignition core is the application of a fly winder to wind the primary winding 23 over the wire rope, prior to cutting it to length. With this approach, the primary winding 23 also serves to mechanically hold the core together. In this case, the above described tape or shrink wrap tube over the core can be optional. Preferably, a protective cap can be employed to hold the wire rope in place as it is fed into the fly winder. After the wire rope is wrapped, the core opposite the cap is cut off and the cap repositioned length of wire rope on the roll.

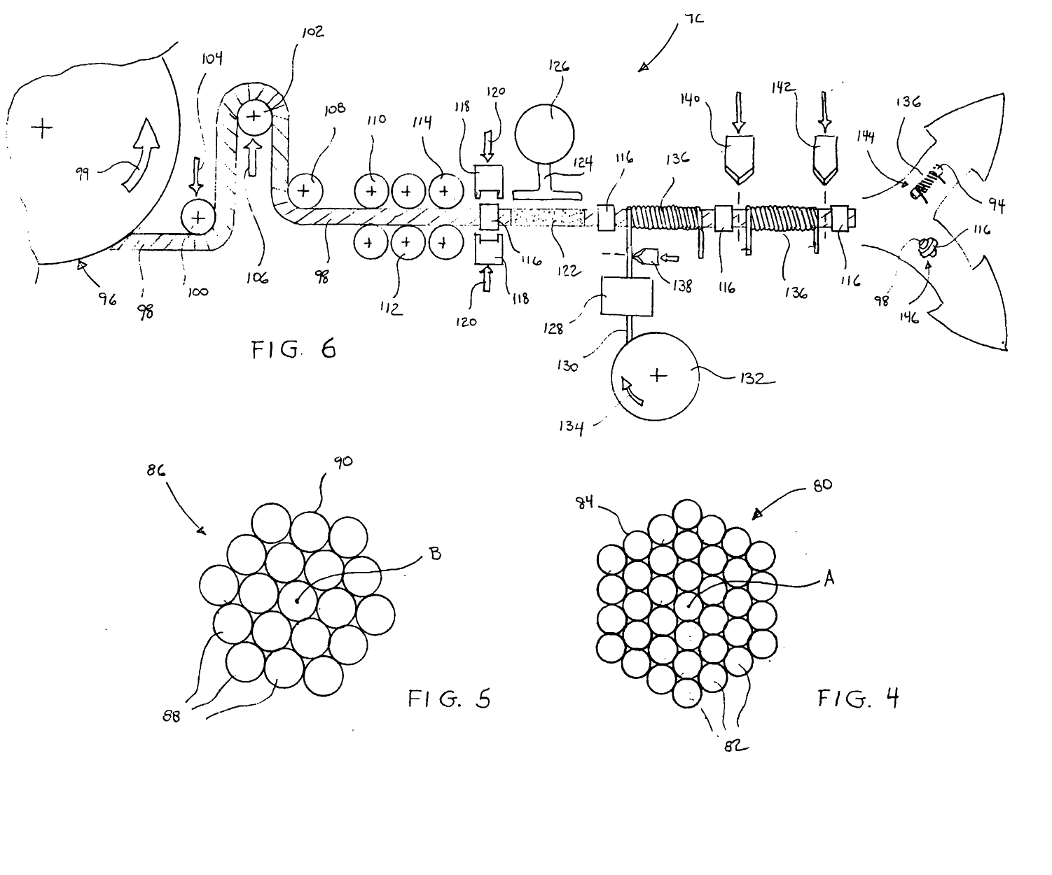

Referring to FIG. 4, a typical cross-section of the preferred type 1x37 type steel rope 80 is illustrated. An appropriate length of this type of steel rope 80 is cut-off normally to its axis of elongation (A). Steel rope 80 is constructed of 37 individual strands 82, each of which is ideally coated with a layer 84 of relatively non-conductive material such as naturally occurring oxide. Alternatively, unplated raw steel or various types of anodizing or plating (such as zinc) can be successfully employed. The individual strands 82 are tightly packed with one another to approximate line-to-line contact between adjacent strands 82, minimizing the amount of air within the volume defined by the steel rope 80 and approximating a cylindrical overall shape. The strands 82 can be formed, by way of example, from ferrite based material such as low carbon steel, iron, 400 series stainless steel, and the like.

In typical applications within automotive internal combustion engines envisioned by the inventors, each steel rope 80 core should have an axial length within the range of 25.0 mm to 80.0 mm. The individual strands 82 are of the same constant or nominal diameter within the range of 0.5 mm to 2.0 mm. The strands 82 are generally helically arranged (with the possible exception of the center strand) along their entire axial length. The outer strands 82 have a characteristic continuous wrap angle exceeding 180° (½ turn) to collectively self-engage one another and retain the steel rope in its illustrated configuration during the manufacturing/assembly process.

Referring to FIG. 5, a typical cross-section of an alternative type 1x19 type steel rope 86 is illustrated. As in the case of the preferred embodiment described in conjunction with FIG. 4, an appropriate length of this type of steel rope 86 is cut-off normally to its axis of elongation (B). Steel rope 86 is constructed of 19 individual strands 88, each of which is preferably coated with a layer 90 of relatively non-conductive material.

As in the case of the above described prior art composite core, the primary coil 23 is wound directly on the outer surface of the presently inventive core 25. The windings are formed from insulated wire, which are wound directly upon the outer cylindrical surface of the core 25. The primary coil 23 may be comprised of two winding layers each being comprised of 127 turns of No. 23 AWG wire. Adhesive coatings, though not foreseeably required, may be applied to the primary coil 23 such as by conventional felt dispenser during the winding process or by way of a partially cured epoxy coat on the wire which is heat cured after winding. The winding of the primary coil 23 directly upon the core 25 provides for efficient heat transfer of the primary resistive losses and improved magnetic coupling which is known to vary substantially inversely proportionally with the volume between the primary winding 23 and the core 25.

The connector body 11 is also preferably molded from Valox®, however, in a conventional insert molding process to capture the core grounding terminal 41 and a pair of primary terminals (not illustrated). The core grounding terminal 41 has a portion thereof exposed at the base of an axial cavity 55 at the interior end portion of connector body 11. The primary terminals extend into a connector well 53 for coupling to the primary energization circuitry external to the integrated ignition coil and spark plug assembly 10. A radially yieldable connector 15 is crimped to core grounding terminal 41, allowing for a terminal tail portion to be extensibly disposed therefrom. A core grounding spring 39 is assembled into the cavity at the interior end portion of the connector body 11. The core 25 is assembled to the interior end portion of the connector body 11 compressing the core grounding spring 39 to establish positive electrical contact between the core 25 and the core grounding terminal 41. The terminal leads (not illustrated) of the primary coil 23 are connected to the insert molded primary terminals by soldering.

The primary sub-assembly is next inserted into the secondary spool 21 with a slight interference fit of the outer surface of the interior end portion of the connector body 11 to the interior surface of the secondary spool 21. A spring jumper 17 flexibly connects the tang 19A of the secondary grounding terminal 19 to the terminal tail portion extensibly disposed from the core grounding terminal 41.

The outer case 51 is formed from round tube stock preferably comprising nickel plated 1008 steel or other adequate magnetic material. Where higher strength may be required, such as, for example, in unusually long cases 5 1, a higher carbon steel or a magnetic stainless steel may be substituted. A portion of the case 51 at the end adjacent the connector body 11 is preferably formed by a conventional swage operation to provide a plurality of flat surfaces to provide a fastening head, such as a hexagonal fastening head 56 for engagement with standard drive tools. Additionally, the extreme end is rolled inwardly to provide necessary strength for torques applied to the fastening head 56 and to provide a shelf for trapping a ring clip 43 between the case 51 and the connector body 11. The previously assembled primary and secondary sub-assemblies are loaded into the case 51 from the spark plug end to a positive stop provided by the swaged end acting on a portion of the connector body 11. Additionally, a plurality of radially extending spacers 57 provide for substantial centering and limited range of radial motion of the primary and secondary sub-assemblies within the case 51.

The entire assembly is then filled with a predetermined volume of fluidic dielectric suitable for the high temperature and high voltage environment of the integrated ignition coil and spark plug assembly 10. A general category of Polydimethyl siloxane oils have demonstrated dielectric properties, volume resistivity properties and heat dissipation properties considered to be adequate for automotive engine applications. For example, one such commercially available fluid is identified as SF97-50 silicone dielectric fluid available from General Electric Corporation. Another such commercially available fluid includes 561™ fluid marketed by Dow Corning. The volume of fluid fill is sufficient to completely submerge the secondary assembly when the integrated ignition coil and spark plug assembly 10 is in a normally installed position. A volume between the connector body 11 just below the O-ring 13 and the top of the secondary assembly provides an expansion chamber 63 for volumes of fluid displaced during the normal course of thermal expansions of the components and the effective volume changes of the primary and secondary sub-assemblies. After fluid fill, the ring clip 53 is installed to prevent the primary and secondary assemblies from being pulled back through the case opening.

Next, the spark plug assembly 59 is installed to close the end of the case 51 opposite the connector body 11. The spark plug assembly 59 includes a conductive outer shell 33 surrounding a ceramic spark plug insulator 31 through which axially passes a high voltage center electrode 47 (hereinafter the negative electrode) including an RFI suppression resistor (not illustrated). The conductive outer shell 33 tapers down to a threaded portion 77 which threadably engages into the combustion cylinder head of the associated internal combustion engine. Extending from the bottom of threaded portion 77 and over center of an exposed portion 71 of negative electrode 47 is a complementary ground electrode 73. An ionization gap 45 is thereby established between respective negative and positive electrodes 47 and 73. Surrounding an exposed portion of the negative electrode 47 and in electrical contact therewith is a high voltage contact spring 49. The distal end of the high voltage contact spring 49 is engaged with a recessed portion of the spacer 29. An interior tang 35B integral with the secondary negative terminal 35 is in electrical contact with the contact spring 49 to thereby couple the high voltage output of the secondary coil 37 to the electrode 47. A weld seam 61 runs about the entire perimeter between the end of the case 51 and the conductive housing 33 of the spark plug assembly 59 such as by a conventional resistance welding process thus completing the assembly steps of the integrated ignition coil and spark plug assembly 10 and providing a structurally robust, electrical and hermetically sealed joint.

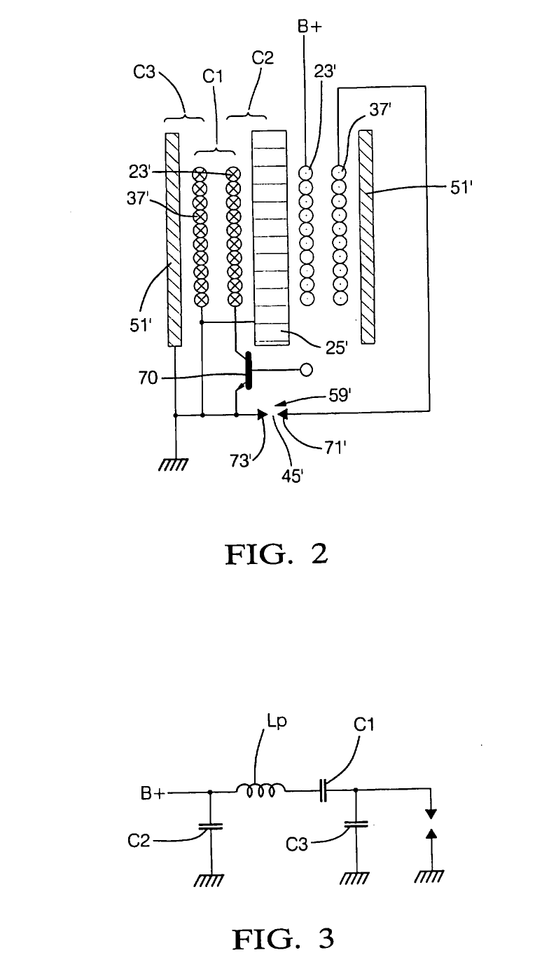

With reference now to FIGS. 2 and 3, the embodiment of the invention illustrated with particularity in FIG. 1 is shown in simplified form wherein certain of the electrical and magnetic circuit elements are labeled with primed designations of corresponding features of FIG. 1. The core 25′ is shown surrounded in progressive coaxial fashion by primary coil 23′, secondary coil 37′ and outer case 51′. One lead of the primary coil 23′ is seen to be coupled to system voltage labeled B+ in the riffle. The B+ coupling would be by way of an external connection provided by the connector body 11 (FIG. 1) at one end of the assembly. The other lead of the primary coil 23′ is selectively coupled to vehicle or chassis ground by way of a controllable semi-conductor switch 70. Semi-conductor switch 70 is controlled in a well known manner in accordance with predetermined ignition timing objectives for each cylinder by a conventional spark timing module in response to sensed angles of engine rotation as is generally well known in the art. The core 25′ and the primary coil 23′ capacitively couple, one with the other, the equivalent capacitance being labeled C2 in FIGS. 2 and 3. The equivalent capacitance C2 is relatively large due in great part to the proximity of the core 25′ and the primary coil 23′. One lead of the secondary coil 37′ is directly coupled to the exposed portion 71 ′ of the negative electrode of the spark plug assembly 59′. The other (secondary) electrode 73′ of the spark plug assembly 59′ is direct coupled to vehicle ground. The secondary coil 37′ and the primary coil 23′ capacitively couple, one with the other, the equivalent capacitance being labeled C1 in FIGS. 2 and 3. The outer case 51′ encloses the core 25′ as well as the primary and secondary coils 23′ and 37′, respectively.

In accordance with the invention, the outer case 51′ is directly coupled to the vehicle ground by way of the threaded portion 77 of the spark plug assembly 59 (FIG. 1). The core 25′ is also, in accordance with the present invention, directly coupled to vehicle ground through the outer case 51′, as described in accordance with the embodiment illustrated in FIG. 1. The outer case 51′ and the secondary coil 37′ capacitively couple, one with the other, the equivalent capacitance being labeled C3 in FIGS. 2 and 3. Attenuation of the RFI generated by the sparking event of the spark plug is advantageously provided by a ladder type RFI filter modeled by a simplified equivalent circuit in FIG. 3: As indicated, the proximity of the primary winding 23 afforded by the direct winding thereof on the core 25 (FIG. 1) provides a relatively large equivalent capacitance C2. The grounding of the outer case 25 establishes an equivalent capacitance C3 between the vehicle ground and then secondary winding 37 (FIG. 1) on one side of the equivalent primary inductance Lp. The grounding of the core 25 establishes an equivalent capacitance C2 between the vehicle ground and the other side of the equivalent primary inductance Lp. RFI otherwise capacitively coupled in parallel across the equivalent primary inductance Lp, especially because of the inherently large capacitive effects of winding the primary coil 23 directly upon the core 25 (FIG. 1), is instead attenuated by the equivalent ladder network, thus greatly reducing the direct coupling to the supply voltage B+.

Referring to FIG. 6, a manufacturing process or line, shown generally at 92, illustrates a simple, inexpensive method for producing magnetic cores 94 for use in ignition coil apparatus as described herein. A large (substantially continuous) supply roll 96 of wire rope 98 plays off wire rope 98, as indicated by arrow 99, which then passes around guide pulleys 100, 102. Guide pulleys 100, 102 are controllably displacable, as indicated by arrows 104, 106, to tension the wire rope 98 passing thereover. Thereafter, the wire rope 98 passes over another guide pulley 108 and between three pairs of straightening pulleys 110, 112 and 114. Next, temporary bands 116 are applied to wire rope 98 at spaced points therealong to define the respective predetermined end points with a length of wire rope 98 therebetween. The bands 116 are provided by a feed mechanism (not illustrated) and are applied to the wire rope 98 by a suitable clamping mechanism 118 which reciprocates as indicated by arrows 120.

In the next process step, a layer of electrically insulating contact adhesive 122 is applied between adjacent bands 116 on wire rope 98 by a dispenser 124 connected to a reservoir 126. Thereafter, a fly winder 128 draws a feed of wire 130 off a continuous spool 132 as indicated by arrow 134. The fly winder 128 serves to axially wrap the wire 130 over the adhesive layer 122 on the adjacent length of wire rope 98, effecting adhesive bonding thereof. This step effects formation of the primary coil 136. Wire 130 is severed by a sheer 140, completing formation of the primary coil 136. Finally, the length of wire rope 98 between adjacent bands 116 is severed from the remainder of the in-process wire rope 98 by a pair of sheers 140, 142, or other suitable device. The output of process line 92 consists of assemblies 144 of magnetic cores 94 and primary coils 136, which are accumulated for subsequent final assembly in the ignition coil, and the chaff 146 consisting of stubs of wire rope 98 and bands 98 are discarded or recycled.

As best viewed in FIGS. 1A and 1B, almost the entire axial length of the magnetic core 25 is swaddled by the primary coil 23. This prevents any relative movement or separation of the strands of the woven rope making up the magnetic core. The idealized wire rope cross-sections depicted in FIGS. 4 and 5 are actually hexagonally-shaped as opposed to truly circular. Wire ropes with differing strand sizes and arrangements can be employed in known wrap configurations to more closely approximate a circular cross-section.

FIG. 1A depicts the uppermost end portion 148 of the wire rope core 25 which is not covered by the primary coil 23. Uppermost portion 148 of the wire rope core 25 is nestingly disposed within a downwardly opening pocket 150 integrally formed within connector body 11 to prevent any unraveling of the strands of the wire rope core 25 in application. The core grounding spring 39 is disposed within the pocket 150 and continuously bears downwardly against the upper end surface 152 of the wire rope core 25 to maintain an electrical interconnection therewith.

FIG. 1B depicts the lowermost end portion 154 of the wire rope core 25 which is not covered by the primary coil 23. Lowermost portion 154 of the wire rope core 25 is nestingly disposed within an upwardly opening pocket 156 integrally formed within the spacer 29 to prevent any unraveling of the strands of the wire rope core 25 in application. The compression spring 27 is disposed within the pocket 156 and continuously bears upwardly against the lower end surface 158 of the wire rope core 25 to maintain the wire rope core 25 in its illustrated position.

It is to be understood that the invention has been described with reference to specific embodiments and variations to provide the features and advantages previously described and that the embodiments are susceptible of modification as will be apparent to those skilled in the art.

Furthermore, it is contemplated that many alternative, common inexpensive materials can be employed to construct the basis constituent components. Accordingly, the forgoing is not to be construed in a limiting sense.

The invention has been described in an illustrative manner, and it is to be understood that the terminology, which has been used is intended to be in the nature of words of description rather than of limitation.

Obviously, many modifications and variations of the present invention are possible in light of the above teachings. For example, although the present invention is illustrated as embodied in a so called “pencil core structure” wherein the spark plug assembly and the ignition coil are integrated into a single apparatus, it can also be applied with equal success within separate mount ignition coil/spark plug(s) arrangements such as those described in the specifications of the patent references incorporated herein. It can be applied with and without dielectric fluids. It is, therefore, to be understood that within the scope of the appended claims, wherein reference numerals are merely for illustrative purposes and convenience and are not in any way limiting, the invention, which is defined by the following claims as interpreted according to the principles of patent law, including the Doctrine of Equivalents, may be practiced otherwise than is specifically described.

1. An ignition coil apparatus comprising:
a generally cylindrical magnetic core having opposed first and second ends;
a primary coil concentrically wound about the core between the first and second ends;
a secondary coil assembly including an insulating spool and secondary coil wound thereon, said secondary coil assembly concentrically disposed with said primary coil and magnetic core;
means for electrically interconnecting one terminal of said primary coil to a controlled voltage source and another terminal of said primary coil to an electrical ground; and
means for electrically interconnecting one terminal of said secondary coil to the high voltage terminal of at least one spark plug and another terminal of said secondary coil to an electrical ground,
said magnetic core comprising a wire rope formed of a plurality of helically arranged low carbon steel or iron strands extending between said first and second ends.

2. The ignition coil apparatus of claim 1, wherein said wire rope is of standard 1x37 construction.

3. The ignition coil apparatus of claim 1, wherein said wire rope is of standard 1x19 construction.

4. The ignition coil apparatus of claim 1, further comprising an electrically insulative member disposed intermediate said magnetic core and said primary coil.

5. The ignition coil apparatus of claim 1, further comprising:
a magnetic case disposed concentrically about said magnetic core, primary coil and secondary coil assembly, said magnetic case adapted for connection to an electrical ground.

6. The ignition coil apparatus of claim 1, wherein each steel strand within said wire rope is of common diameter.

7. The ignition coil apparatus of claim 1, wherein said steel strands have a nominal diameter substantially within the range of 0.5 mm to 2.0 mm.

8. The ignition coil apparatus of claim 1, wherein said wire rope has a nominal axial length of 25.0 mm to 80.0 mm.

9. The ignition coil apparatus of claim 1, wherein each strand of said wire rope is zinc plated.

10. The ignition coil apparatus of claim 1, wherein the radially outermost strands of said wire rope have a substantially constant characteristic pitch throughout the axial extent thereof.

11. The ignition coil apparatus of claim 10, wherein said radially outermost strands of said wire rope have a wrap angle exceeding 180° or ½ turn.

12. The ignition coil apparatus of claim 1, further comprising a surface coating on at least some of said strands, said surface coating being formed of a relatively non-electrically conductive material.

13. The ignition coil apparatus of claim 1, wherein said surface coating is an oxide material.

14. An integrated spark plug and ignition coil apparatus comprising:
a spark plug assembly including a central negative electrode progressively surrounded by a ceramic insulator and a conductive outer shell, said conductive outer shell including a ground electrode extending from a threaded portion adapted for engagement to a combustion cylinder head;
a substantially cylindrical case formed from magnetic material having first and second ends, said case welded to the conductive outer shell of the spark plug assembly at the first end and fixably and sealingly engaged to a connector body at the second end;
an ignition coil assembly including a primary coil wound upon a magnetic core formed of steel rope composed of a plurality of helically arranged, inter-engaging low carbon steel strands extending substantially parallel to a characteristic line of elongation and defining a generally cylindrical outer surface, the ignition coil further including a secondary coil wound concentrically in segments about the primary coil and separated therefrom by an insulative spool, said ignition coil assembly concentrically disposed within said case in spaced adjacency therefrom and fixably engaged at one end thereof to the connector body and axially yieldably engaged at the other end thereof to the spark plug assembly; and
a volume of dielectric fluid contained within the confines of the case, spark plug assembly and connector body substantially covering the ignition coil assembly.

15. The integrated spark plug and ignition coil apparatus of claim 14, wherein said wire rope comprises 37 common diameter steel strands.

16. The integrated spark plug and ignition coil apparatus of claim 14, wherein said wire rope comprises 19 common diameter steel strands.

17. The integrated spark plug and ignition coil apparatus of claim 14, further comprising an electrically insulative member substantially covering the entire outer surface of said wire rope along its axial extent intermediate said wire rope and said primary coil.

18. The integrated spark plug and ignition coil apparatus of claim 14, further comprising a plurality of circumferentially disposed flat surfaces formed on said case at the end thereof adjacent said connector body adapted for engagement with a tool for transmitting torque to the case.

19. A method of forming an ignition coil apparatus comprising a magnetic core, a primary coil and a secondary coil assembly including an insulating spool and secondary coil wound thereon, said method comprising the steps of:
drawing a predetermined length of wire rope from a substantially continuous supply;
straightening said predetermined length of wire rope;
wrapping a conductor about said length of wire rope to form said primary coil;
severing said length of wire rope from said continuous supply to form said magnetic core; and
concentrically positioning said magnetic core and primary coil within said secondary coil assembly.

20. The method of claim 19, further comprising the step of axially tensioning said predetermined length of wire rope prior to wrapping said conductor thereon.

21. The method of claim 19, further comprising the step of affixing bands at spaced locations along said wire rope to define a beginning and end location of each said length of wire rope.

22. The method of claim 19, further comprising the step of applying electrically insulative material on the outer surface of each said length of wire rope prior to wrapping the conductor thereon to form said primary coil.

23. The method of claim 19, further comprising the step of applying adhesive material on the outer surface of each said length of wire rope prior to wrapping the conductor thereon to form said primary coil.
